(19) United States
(12) Patent Application Publication
(10) Pub. No.: US 2011/0086523 A1
(43) Pub. Date: Apr. 14, 2011

(54) Battery Connector

(76) Inventors: Chih-Lin Yang, Tu-Cheng City (TW); Hsin-Tsung Ho, Tu-Cheng City (TW)

(21) Appl. No.: 12/577,723

(22) Filed: Oct. 13, 2009

(51) Int. Cl. H01R 12/00

(52) U.S. Cl. 439/83

(57) ABSTRACT

A battery connector is mounted on a printed circuit board which defines a holding hole therein. The battery connector includes an insulating housing, a plurality of conductive terminals and a fastening member disposed in the insulating housing respectively. The insulating housing defines a plurality of terminal recesses each extending vertically and longitudinally to pass through a top surface and a front surface thereof. The front surface defines a shallow depression. Each of the conductive terminals has a contact portion and a soldering portion exposed from the front surface for being soldered on the printed circuit board. The fastening member has a base board engaged in the shallow depression and exposed from the front surface for being soldered on the printed circuit board. A soldering tail is extended opposite to the insulating housing from a portion of the base board for being inserted into the holding hole.

### BACKGROUND OF THE INVENTION

1. Field of the Invention

The present invention generally relates to an electrical connector, and more particularly to a battery connector.

2. The Related Art

A conventional battery connector includes an insulating housing defining a plurality of terminal recesses therein, and a plurality of conductive terminals disposed in the respective terminal recesses. Each of the conductive terminals has a base portion received in the corresponding terminal recess. An edge of the base portion is bent downward to form a soldering portion exposed out of the insulating housing for soldering with a printed circuit board. An opposite edge of the base portion crookedly extends upward to form an elastic portion received in the terminal recess. A free end of the elastic portion extends upward to form a contact portion stretching out of the insulating housing for contacting a corresponding battery.

However, the battery connector is engaged with the printed circuit board only by means of the soldering portions soldering with the printed circuit board, so the battery connector is apt to break off from the printed circuit board when the battery is mated with the battery connector. As a result, a connection between the battery connector and the printed circuit board is not firm that further results in an unstable electrical connection between the battery and the battery connector. Therefore, a battery connector capable of overcoming the foregoing problem is required.

### SUMMARY OF THE INVENTION

An object of the present invention is to provide a battery connector. The battery connector is for being mounted on a printed circuit board which defines a holding hole therein. The battery connector includes an insulating housing, a plurality of conductive terminals and a fastening member disposed in the insulating housing respectively. The insulating housing defines a plurality of terminal recesses each extending vertically and longitudinally to pass through a top surface and a front surface thereof. The front surface defines a shallow depression. The conductive terminals are disposed in the respective terminal recesses. Each of the conductive terminals has a contact portion exposed from the top surface and a soldering portion exposed from the front surface for being soldered on the printed circuit board. The fastening member has a base board engaged in the shallow depression of the insulating housing and exposed from the front surface for being soldered on the printed circuit board. A soldering tail is extended opposite to the insulating housing from a portion of the base board for being inserted into the holding hole.

As described above, the fastening member is utilized to make the base board engaged in the shallow depression for being soldered on the printed circuit board and the soldering tail thereof inserted into the holding hole, so a stable electrical connection can be achieved between the battery connector and the printed circuit board.

### BRIEF DESCRIPTION OF THE DRAWINGS

The present invention will be apparent to those skilled in the art by reading the following description, with reference to the attached drawings, in which:

FIG. 1 is a perspective view of a battery connector in accordance with the present invention;

FIG. 2 is an exploded view of the battery connector of FIG. 1;

FIG. 3 is a sectional view of an insulating housing of the battery connector of FIG. 1;

FIG. 4 is another sectional view of the insulating housing of the battery connector of FIG. 1; and

FIG. 5 is a sectional view showing that the battery connector of FIG. 1 is assembled with a printed circuit board.

### DETAILED DESCRIPTION OF THE PREFERRED EMBODIMENT

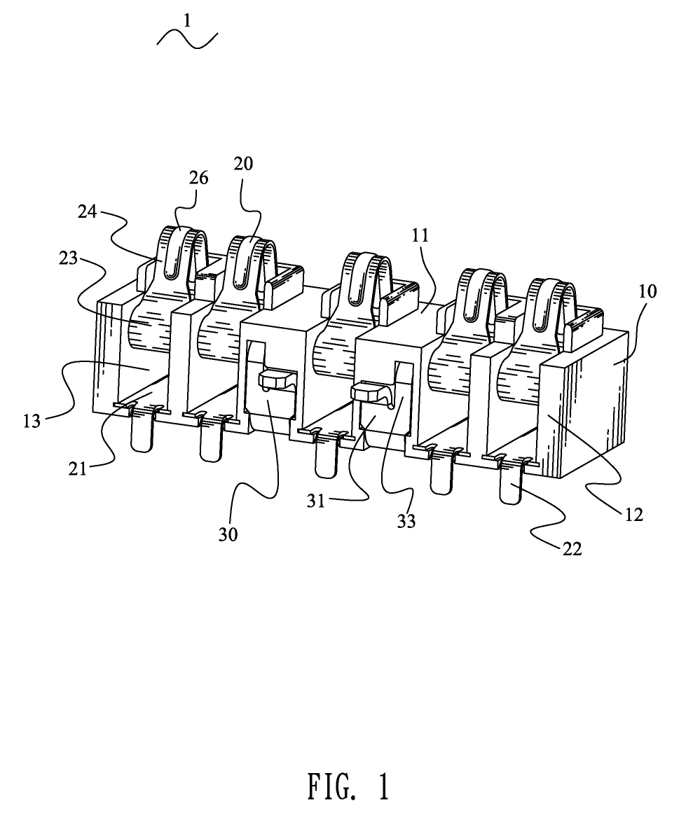

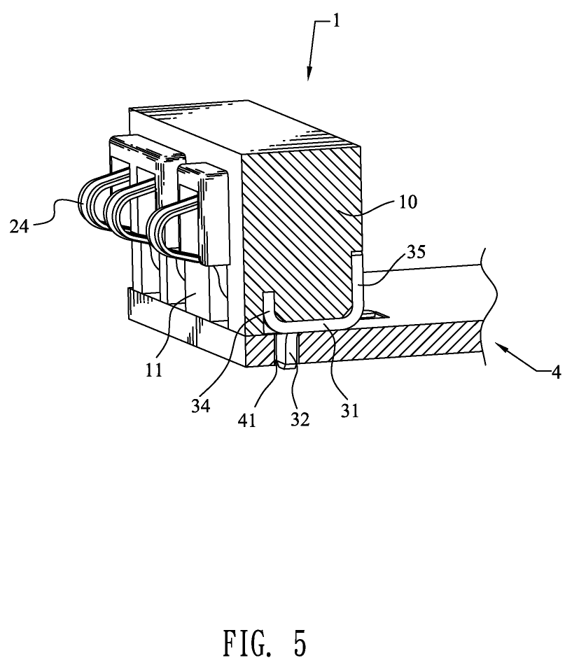

With reference to FIG. 1 and FIG. 5, a battery connector 1 of the present invention adapted to be mounted on a printed circuit board 4 includes an insulating housing 10, a plurality of conductive terminals 20 and a pair of fastening members 30 disposed in the insulating housing 10 respectively.

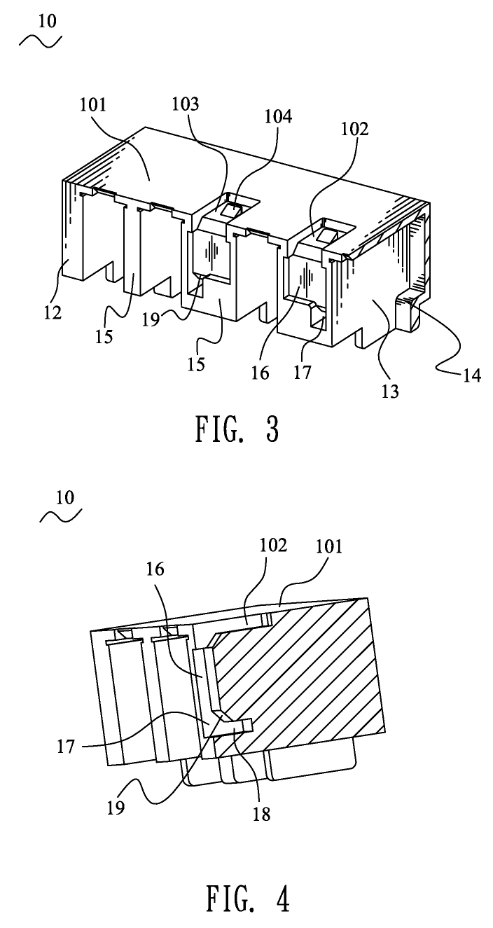

Referring to FIGS. 1-4, the insulating housing 10 is of rectangular shape. The insulating housing 10 defines a plurality of rectangular terminal recesses 13 arranged at regular intervals along a transverse direction thereof and each extending vertically and longitudinally to pass through a top surface 11 and a front surface 12 thereof. A rear side of the terminal recess 13 protrudes forward to form a holding portion 14 extending transversely at an upper portion of the terminal recess 13. A plurality of separating walls 15 each is accordingly formed between two adjacent terminal recesses 13 of the insulating housing 10. Two of the separating walls 15 which are located in a substantial middle of the insulating housing 10 each defines an L-shaped recess including a rectangular shallow depression 16 defined in the front surface 12 and a rectangular fixing groove 102 passing through a bottom surface 101 to make the recess span a front bottom corner of the corresponding separating wall 15. a top corner of the shallow depression 16 further extends upward to form a holding groove 17 respectively. A distal end of the holding groove 17 extends inward to form an inserting groove 18. A slope 19 is smoothly formed at a junction of the inserting groove 18 and the second holding groove 17. A middle of a top wall 103 of the fixing groove 102 is protruded downward to form a wedge 104.

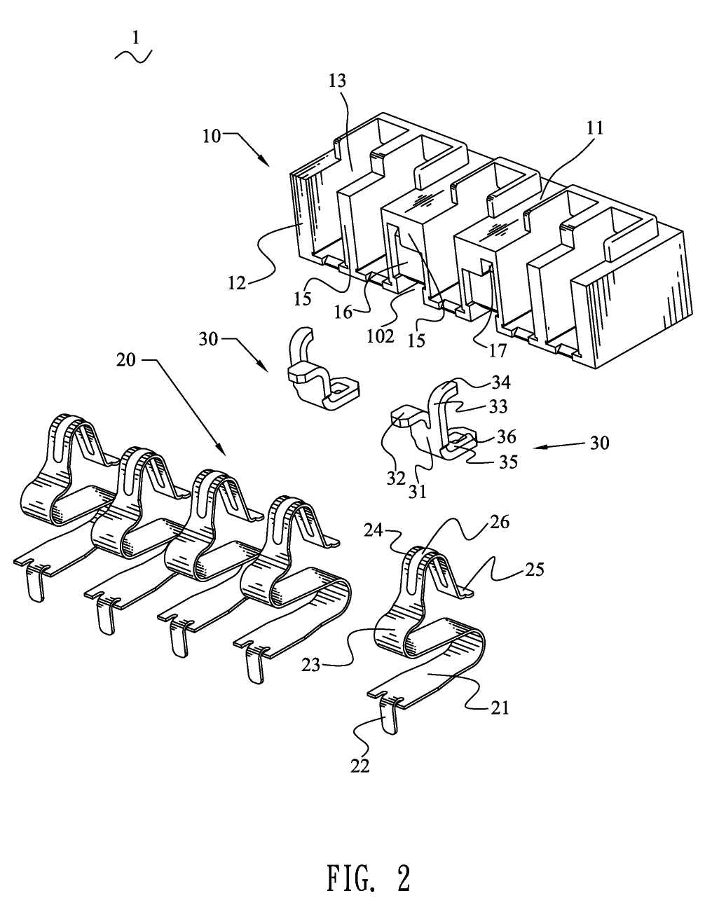

Referring to FIGS. 1-2, each of the conductive terminals 20 has a base portion 21 of rectangular plate shape. A middle of a front edge of the base portion 21 is perpendicularly bent to form a soldering portion 22. A rear edge of the base portion 21 extends towards an opposite direction to the soldering portion 22 to form an elastic portion 23 with a substantial serpentine shape. A free end of the elastic portion 23 further extends to form an inverse-V shaped contact portion 24 with an opening facing the elastic portion 23. A free end of the contact portion 24 is bent outward to form a propping portion 25 substantially paralleling to the base portion 21. A holding rib 26 is formed to span a middle of an outer surface of the contact portion 24 along an extending direction of the contact portion 24.

Referring to FIGS. 1-2 and FIG. 5, each of the fastening members 30 has a rectangular base board 31. A side of an edge of the base board 31 is bent perpendicularly to form a soldering tail 32. The other side of the edge of the base board 31 further extends to form a holding arm 33 of which a free end is bent towards an opposite direction to the soldering tail 32 to form an inserting portion 34. An opposite edge of the base board 31 is bent towards the same direction as the inserting portion 34 to form a fixing board 35. The fixing board 35 is of substantial rectangular shape and defines an opening 36 passing through a middle thereof. The printed circuit board 4 defines a pair of holding holes 41 aligned with each other along a transverse direction thereof and each perpendicularly passing therethrough.

Referring to FIGS. 1-5, in assembly, the base portion 21 and the elastic portion 23 of each of the conductive terminals 20 are disposed in the corresponding terminal recess 13 of the insulating housing 10. The contact portion 24 stretches out of the top surface 11 of the insulating housing 10 to contact with a mating battery (not shown). The propping portion 25 is restrained under the corresponding holding portion 14 of the insulating housing 10 for restraining the contact portion 24 of the conductive terminal 20. The conductive terminal 20 can bear a relatively great external force by means of the holding rib 26 on the contact portion 24. The soldering portion 22 is exposed from the front surface 12 of the insulating housing 10 for being soldered with the printed circuit board 4. The fastening member 30 is inserted rearward in the insulating housing 10 with the base board 31 being held in the corresponding shallow depression 16 to be substantially in a same plane as the soldering portions 22 of the conductive terminals 20, the holding arm 33 being held in the corresponding holding groove 17, the inserting portion 34 being inserted into the corresponding inserting groove 18 through the corresponding slope 19 and the fixing board 35 being fixed in the corresponding fixing groove 102 by means of the wedge 104 being buckled in the corresponding openings 36. The soldering tail 32 is exposed out of the front surface 12 of the insulating housing 10 and inserted into the corresponding holding holes 41 of the printed circuit board 4 to be further soldered with the printed circuit board 4 firmly. The base board 31 of the fastening member 30 which is in the substantial same plane as the soldering portions 22 of the conductive terminals 20 can be also soldered with the printed circuit board 4 by means of surface mounted technology so as to increase contact area of the battery connector 1 and the printed circuit board 4 for ensuring a stable electrical connection between the battery connector 1 and the printed circuit board 4.

As described above, the fastening members 30 are utilized to make the soldering tails 32 thereof inserted into the corresponding holding holes 41 and then soldered with the printed circuit board 4 firmly, and furthermore, to enable the base boards 31 thereof also soldered with the printed circuit board 4 by means of the base boards 31 being located in the substantial same plane as the soldering portions 22 of the conductive terminal 20 so as to ensure a firm engagement between the battery connector 1 and the printed circuit board 4. So a stable electrical connection can be achieved between the battery connector 1 and the printed circuit board 4.

The forgoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A battery connector for being mounted on a printed circuit board which defines a holding hole therein, comprising:
an insulating housing defining a plurality of terminal recesses each extending vertically and longitudinally to pass through a top surface and a front surface thereof, the front surface defining a shallow depression;
a plurality of conductive terminals disposed in the respective terminal recesses, each of the conductive terminals having a contact portion exposed from the top surface and a soldering portion exposed from the front surface for being soldered on the printed circuit board; and
a fastening member having a base board engaged in the shallow depression of the insulating housing and exposed from the front surface for being soldered on the printed circuit board, a soldering tail being extended opposite to the insulating housing from a portion of the base board for being inserted into the holding hole.

2. The battery connector as claimed in claim 1, wherein the soldering tail is further soldered with the printed circuit board.

3. The battery connector as claimed in claim 1, wherein the soldering tail is bent perpendicularly from a side of an edge of the base board.

4. The battery connector as claimed in claim 2, wherein a corner of the shallow depression extends perpendicularly to form a holding groove, a distal end of the holding groove is recessed inward to form an inserting groove, the other side of the edge of the base board is extended to form a holding arm held in the holding groove, a free end of the holding arm is bent towards an opposite direction to the soldering tail to form an inserting portion inserted in the inserting groove.

5. The battery connector as claimed in claim 4, wherein the inserting portion of the fastening member is in a different plane from the soldering tail of the fastening member.

6. The battery connector as claimed in claim 4, wherein an opposite end of the shallow depression further longitudinally extends inward to form a fixing groove, an opposite edge of the base board is bent towards the same direction with the inserting portion to form a fixing board fixed in the fixing groove.

7. The battery connector as claimed in claim 6, wherein the fixing board defines an opening passing therethrough, a wedge is protruded in the fixing groove for being buckled in the opening.

8. The battery connector as claimed in claim 7, wherein the inserting groove is formed at a top of the shallow depression, the fixing groove is formed at a bottom of the shallow depression.

9. The battery connector as claimed in claim 1, wherein the conductive terminal further has a base portion and an elastic portion elastically connecting the base portion to the contact portion, the base portion and the elastic portion are located in the corresponding terminal recess.

10. The battery connector as claimed in claim 9, wherein the elastic portion is of substantial serpentine shape and the contact portion is of substantially inverted-V shape.

11. The battery connector as claimed in claim 9, wherein the soldering portion is bent towards an opposite direction to the elastic portion from an opposite edge of the base portion.

12. The battery connector as claimed in claim 9, wherein an upper portion of a rear side of the terminal recess is protruded forward to form a holding portion, a free end of the contact portion is bent outward to form a propping portion restrained by the holding portion.

13. The battery connector as claimed in claim 9, wherein a holding rib is formed to span an outer surface of the contact portion along an extending direction of the contact portion.
